(19) United States
(12) Patent Application Publication
(10) Pub. No.: US 2002/0109570 A1
(43) Pub. Date: Aug. 15, 2002

(54) Electrical contactor with true status indication

(76) Inventors: Madhu Sudan, Bangalore (IN); M. Natarajan, Bangalore (IN); A. Ramadevi, Bangalore (IN); Anilkumar D. Pandit, Bangalore (IN); K.V. Sridhar, Bangalore (IN); Joseph P. Smith, Dorchester, MA (US); Thoung Huy Phung, Bristol, CT (US)

Correspondence Address: PATENT OPERATION, GENERAL ELECTRIC COMPANY, 41 WOODFORD AVENUE, PLAINVILLE, CT, 06062

(21) Appl. No.: 09/681,194

(22) Filed: Feb. 15, 2001

(51) Int. Cl. H01H 67/02

(52) U.S. Cl. 335/132

(57) ABSTRACT

An electromagnetic contactor that provides accurate contactor status indication regardless of the contact position. The primary contacts are secured within reversible contact modules. A contact carrier first end provides accurate local contact position indication. Auxiliary contacts toggled by the operator provide accurate control system status indication. The operator includes a stem with two sets of abutments that cooperatively engage the contact carrier. A catch located at the contact carrier second end and an abutment lip attach if the moveable contacts are welded shut. The operator status is prevented from changing thus insuring the accuracy of the contact position feedback. The contact modules can be installed in the electromagnetic contactor without the use of tools.

### TECHNICAL FIELD

The invention relates generally to switching devices and, in particular, to electrical switching devices providing status indication. The invention further relates to an electromagnetic contactor providing accurate status indication for all operational conditions.

### BACKGROUND OF THE INVENTION

Electromagnetic contactors are presently employed in electrical systems to open and close electrical distribution and control circuits for equipment such as motors, lighting circuits, resistance heaters, control circuits and other electrical loads. Contactors are supplied in a wide range of voltage and current ratings to meet the requirements of the wide variety of electrical equipment with which they are employed.

Generally, the contactor primary contacts are wired in series with an electrical load such as a motor, lighting circuit, control component and the like. The contactor is operated manually or via a control component such as a pushbutton switch, relay, distributed control system or programmable logic controller and the like. The primary contacts include a stationary contact and a moveable contact that form a contact pair. The electrical equipment begins to receive power when the primary contacts are closed and the power circuit is complete. Conversely, the electrical load is de-energized when the contacts open and disconnect the load from the power source.

The contactor status is determined by identifying if the operator is in the energized position or the de-energized position. The operator moves the contact carrier when the operator moves in response to the energization or de-energization of the coil. The moveable contacts are forced to change position as the contact carrier moves between the energized and de-energized position. Thus, the operator status and overall contactor status can be determined from the position of the contacts so long as the contact style is known.

Contactors are manufactured with two contact styles: 1) normally closed; or 2) normally open. The normally closed or normally open position describes the status of a contact pair installed in the contactor with the operator in a de-energized position. Normally open contacts are open when the operator is in the de-energized position and normally closed contacts are closed when the operator is in the de-energized position. The contacts reverse their state when the operator is in the energized position.

Contact position is often used for determining contactor status via monitoring and control systems. However, moveable contacts occasionally get welded in the closed position. Generally, contacts are constructed of silver. Arcs are formed when the contacts open or close while carrying current. Silver vapors created by these arcs may solidify between the moveable and stationary contacts thereby welding the contact pair together. Welded contacts will not freely open because the fused contact surface restrains the moveable contacts. A “soft weld” is a condition where the solidification affects a small area of the contact surface and creates a correspondingly small restraining force.

Some state of the art contactors have an operator that is unattached to the contact carrier. These contactors operate in an unattached arrangement because no contact carrier appendage can attach to the operator and prevent operator travel between an energized and a de-energized position. However, contactor status determined by contact position will be inaccurate when a contact weld occurs when an unattached operator-contact carrier combination is used. For instance, an unattached operator can move to its de-energized position despite the fact that a pair of normally open contacts is welded shut.

State of the art contactors use the contact carrier to provide local contact position and contactor status indication. These contactors allow the user to view the position of the contact carrier in order to identify the position of the moveable contacts. However, the style contact must be known for this visual identification to be accurate.

Additionally, the contactor status is not accurate when an unattached operator is used even where the style contact is known. For example, local contactor status indication will be inaccurate when a contact weld occurs where an unattached operator is used.

State of the art contactors use a return spring to bias the contact carrier in the direction of the de-energized state, and contact springs to provide contact pressure for closed contacts. However, the force of both the return spring and the contact spring oppose contact separation for a normally closed contact pair. The combined spring force creates a high coil inrush current when the contactor is energized and the normally closed contacts are opened. A larger and higher cost electromagnet must be used to overcome these increased force requirements. Alternatively, a more compact electromagnet can be used but compact electromagnets are only rated for intermittent and not continuous duty.

### SUMMARY OF INVENTION

It is therefore advantageous to design an electromagnetic contactor that incorporates both normally open and normally closed contacts and accurate contactor status indication even when contacts are welded shut. It is also seen to be desirable to design an electromagnetic contactor that will separate a moveable and stationary contact that have welded shut. There is also seen to be a need for a reduced inrush normally closed contact style. Additionally, it is desirable to design a contactor that incorporates the preceding features with a contact module that can be field configured for either contact style without using tools or disassembling the contact module. Further, it is desirable to incorporate the preceding features in a contactor wherein the contacts will not provide a false contactor status indication.

Accordingly the present invention provides an electromagnetic contactor that includes contact modules and a contact carrier that provides accurate contactor status indication for all operating conditions. The electromagnetic contactor includes an unattached operator that cooperatively engages the contact carrier to move the moveable contact between an open and a closed position when a contactor coil is energized. The operator and contact carrier attach when the contactor operates with said moveable and stationary contacts welded shut.

The operator motion is transferred to the contact carrier providing a contact separation force capable of breaking a soft weld between the moveable and stationary contacts.

The contact modules are reversible and can be installed in either the normally closed or normally open position without the use of tools. The configuration of the contact spring and the return spring prevent the spring forces from combining to oppose contact separation of normally closed contacts.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF DESCRIPTION OF DRAWINGS

FIG. 1. is an isometric view of an electromagnetic contactor according to the invention;

FIG. 2 is an exploded isometric view of an electromagnetic contactor of FIG. 1;

FIG. 3 is an isometric view of the operator of FIG. 1;

FIG. 4 is an isometric view of a contact module of FIG. 1 with the cover removed;

FIG. 5 is plan view of the contactor cover of FIG. 1;

FIG. 6 is an isometric view of the latch of FIG. 1; and

FIG. 7 is an isometric view of the latch body of FIG. 1.

### DETAILED DESCRIPTION

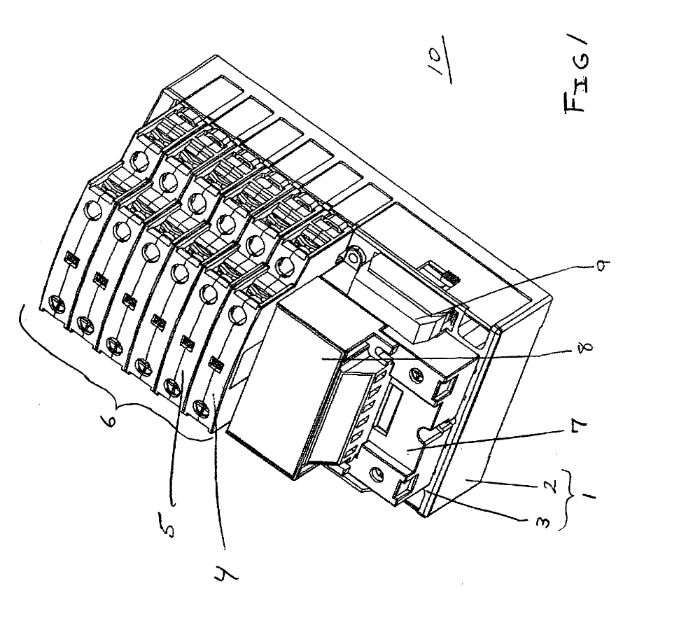

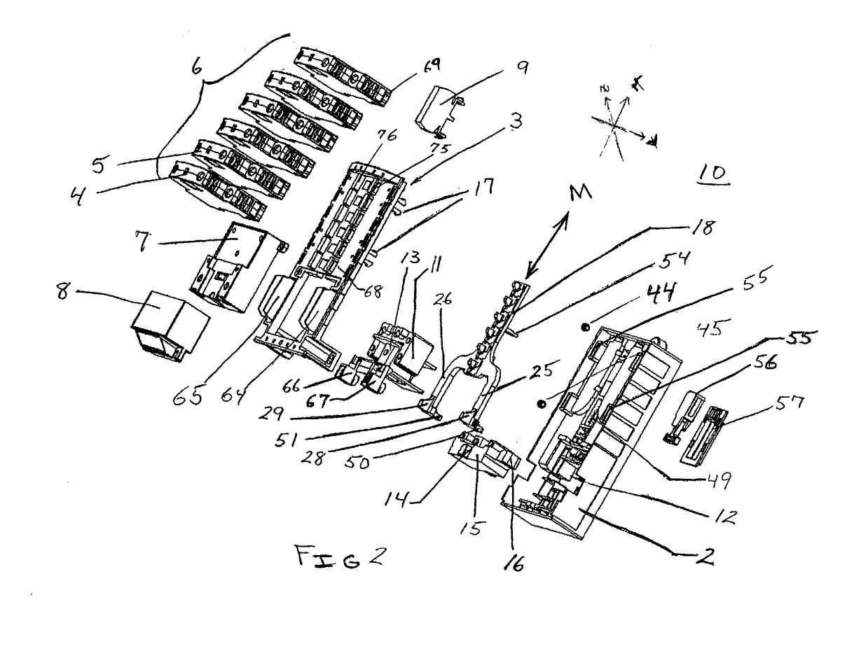

Referring to FIGS. 1 and 2 a preferred embodiment of an electromagnetic contactor 10 includes a housing 1, a coil shield 7, an auxiliary contact block 9, a magnet 11, a coil 13, an armature 14, an operator 18 and at least one contact module 4. A control power source is connected to a first coil terminal 66 and a second coil terminal 67. The electromagnetic contactor 10 changes state when power supplied to the coil 13 via coil terminals 66, 67 is turned on or off.

As seen in FIG. 2, the armature 14 is drawn towards the magnet 11 when the coil 13 is energized. The motion of the armature 14 is transmitted to the operator 18. The operator 18 moves within the housing 1 between an energized and a de-energized position with an operator linear motion represented by vector M. The operator spring 49 is compressed when the operator 18 is in the energized position. The operator spring 49 is relaxed when the operator is in the de-energized position.

In a preferred embodiment, the operator spring 49 is comprised of an outer spring and an inner spring. The dual spring design provides the combination of low inrush and positive contact operation. These features are achieved because the two springs create a variable spring force that increases as the operator 18 moves between the energized and de-energized position. The operator moves against a single spring, the outer spring, as it begins to move from the energized to the de-energized position. However, the operator moves against both the inner and outer springs as the air gap between the armature 14 and magnet 11 decreases. Positive contact operation results because the two springs combine to provide an opening force when the operator 18 is in the energized position.

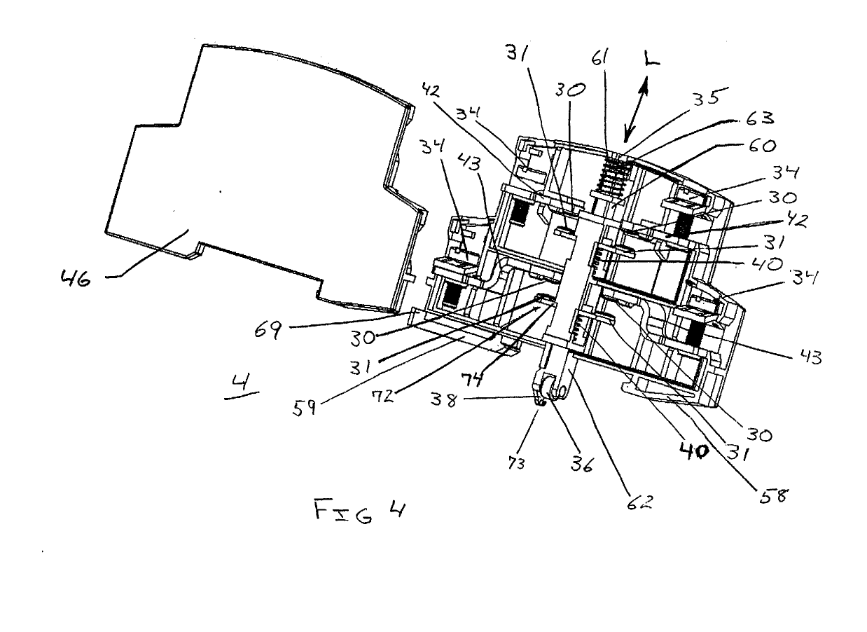

The motion of the operator 18 is transferred to contact module 4 via a contact carrier 60, shown in FIG. 4. The contact carrier 60 travels perpendicular to the direction of the operator linear motion. This motion is represented by vector L, in FIG. 4. FIG. 4 includes a contact module 4 with the module cover 46 removed in order to show the contact module interior. The motion of the contact carrier 60 operates the moveable contacts 31 located in the contact module 4. The contact carrier 60 is a plunger in the preferred embodiment. However, it will be recognized by those skilled in the art that the contact carrier 60 can be embodied by a wide range of structure including toggles, levers and the like so long as the structure can move a contact between the opened and the closed position.

The armature 14 is in its de-energized position when it is located at the furthest position from the coil 13 within the armature range of motion. The air gap between the armature 14 and the magnet 11 is also at a maximum with the armature 14 in its de-energized position. Referring again to FIG. 2, the armature 14 returns to its de-energized position in a motion away from the magnet 11 when power is removed from coil terminals 66, 67 and the coil 13 is de-energized. The operator 18 and contact carrier 60 then return to their de-energized position. The operator returns under the force of the operator spring 49 operating on the operator spring tab 53.

The electromagnetic contactor 10 shown in the figures is specifically a lighting contactor. However, those of skill in the art will recognize that the invention can be embodied in a wide range of contactor types such as motor starter contactors and the like.

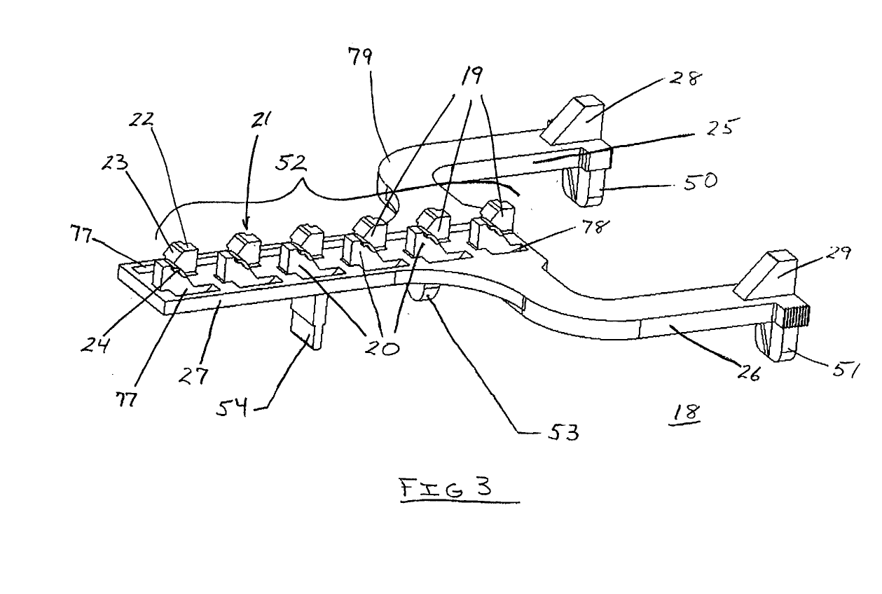

The previously summarized operation will now be described in detail. Referring to FIGS. 1 and 2, the housing 1 is comprised of a base 2 and a cover 3. The operator 18 is secured within the housing 1. The operator 18 slides between the energized and de-energized position on a first stem roller 44 and a second stem roller 45 located in the base 2. The stem rollers 44, 45 engage the underside of the operator 18. An operator spring tab 53, shown in FIG. 3, protrudes from the underside of the stem 27 and engages operator spring 49. The force of the operator spring 49 on operator spring tab 53 biases the operator 18 in the direction of the armature 14. A first leg 2 5 and a second leg 26 are integral with the stem 27. A first foot 50 is located at the distal end of first leg 25, and a second foot 51 is located at the distal end of the second leg 26. Additionally, a side tab 84 is located on both the outer side of the distal end of the first leg 25 and the outer side of the distal end of the second leg 26. The side tabs 84 extend through the side of the base 2 of a fully assembled electromagnetic contactor 10. This is best seen in FIG. 1 In FIG. 1, the magnet 11, coil 13 and armature 14 are installed in a magnet cavity 12 located in the base 2. Coil terminals 66 and 67 are attached to the coil 13 and provide connection points for external control power. First and second legs 25, 26 straddle the magnet 11 and coil 13. The legs 25, 26 engage the armature holder 15 via first foot 50 and second foot 51. Each foot 50, 51 engages one of two flanges 16 located on either side of the armature holder 15 (one flange 16 is shown in FIG. 2 the second flange 16 is obscured in the drawing). The bias of the operator spring 49 on operator 18 is transferred to the armature holder 15 via the first foot 50 and second foot 51. The biasing force pushes the armature holder 15 and attached armature 14 in a direction away from the magnet 11 and coil 13 when the coil 13 is de-energized.

In FIG. 1, the cover 3 attaches to the base 2 to secure the armature 14, magnet 11, coil 13 and operator 18 within the housing 1. A plurality of cover snaps 17 extend from the underside of the cover 3 and provide a snap fit with a plurality of snap recesses 55 located within the base 2. A coil shield 7 is secured to the front of the cover 3 to prevent contact with the components located in the magnet cavity 12. A plurality of contact modules 6 are secured to the cover 3 in either a normally closed or a normally open orientation. The contact modules 6 may be installed in any one of six locations shown in the preferred embodiment. However, those skilled in the art will recognize that the electromagnetic contactor 10 can include any number of contact module positions 68 so long as the operator 18 is operated with sufficient force to operate all the contact modules 6. Additionally, the electromagnetic contactor 10 can operate with less than all available contact module positions 68 full.

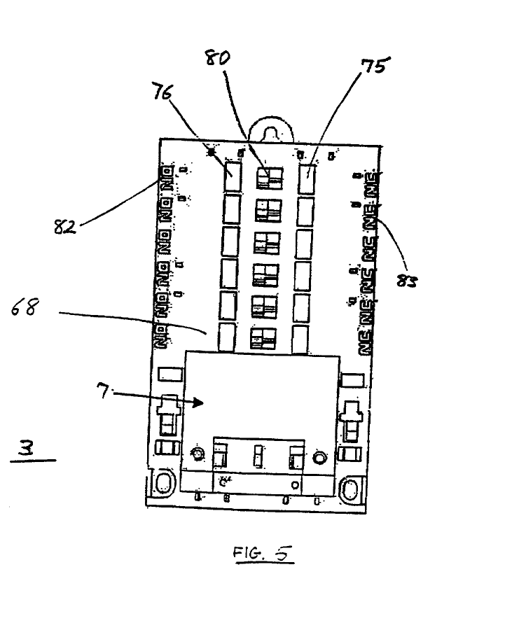

The cover 3 includes access openings 80, shown in FIG. 5, that allow contact carrier 60 secured within contact module 4 to cooperatively engage the stem engagement surface located on the stem 27. The engagement surface has a variable height that in the preferred embodiment includes the first set of abutments 19 and a second set of abutments 20, shown in FIG. 3. It will be recognized by those of skill in the art that the invention can be embodied in a variety of structure such as ramps, peaks, dimples, nubs or other geometric shapes that provide a cam surface for cooperatively engaging the contact carrier 60.

In FIG. 1 the auxiliary contact block 9 is mounted in the first accessory slot 64 via a snap fit. The auxiliary contact block 9 includes at least one auxiliary contact (not shown). A second auxiliary contact block (not shown) may be mounted in the second accessory slot 65 in a similar fashion. FIG. 3 shows the first accessory tab 28 located on the operator face 79 of the distal end of first leg 25 engages an auxiliary contact block 9 installed in the first accessory slot 64. The second accessory tab 29 located on the operator face 79 of the distal end of second leg 26 engages an auxiliary contact block (not shown) installed in the second accessory slot 65. The movement of the operator 18 is transferred to an auxiliary contact block 9 mounted in the first or second accessory slot 64, 65 via the corresponding first or second accessory tab 28, 29. Thus, the auxiliary contacts located in the auxiliary contact block 9 are toggled between the opened and closed position when the operator 18 moves between the energized and de-energized positions. One of the auxiliary contacts provides device status indication to the electronic timer 8 used with the contactor latch 56 that is described herein. The remaining auxiliary contacts are typically used to provide remote contactor status indication via control circuitry.

The contact module 4 includes at least one set of primary contacts comprised of at least one stationary contact 30 and at least one moveable contact 31. A second contact modules 5 with different contact ratings can also be installed for use with the invention.

The contact module 4 of the preferred embodiment, in FIG. 4, includes two sets of contacts. Each set of contacts includes a contact bridge 72 comprised of a conducting cross arm 74 with a moveable contact 31 located at each end of the cross arm 74. The contact bridge 72 is secured to the contact carrier 60 and travels between an open and a closed position as the contact carrier 60 is driven up and down in the contact carrier slot 35. The moveable contacts 31 complete an electrical circuit between terminal screws 34, located on opposite sides of the contact module 4, when the contact carrier 60 is in the raised position. The completed circuit includes two conductors 43. Each conductor 43 is connected to a terminal screw 34 and a corresponding stationary contact contact 30. The moveable contacts 31 connect the two stationary contacts 30 to one another via the contact bridge 72 when they are in a closed state. Return spring 63 provides a biasing force that drives the contact carrier 60 downward to separate the moveable contacts 31 from stationary contacts 30 except when the contact carrier 60 is held in the raised position by the operator 18.

The contact pressure of the contact pair formed by contacts 30, 31 is provided by a contact spring 40. The contact spring 40 provides a biasing force on the contact bridge 72 in the direction of the contact carrier first end 61. The contact spring 40 begins to compress when the moveable contact 31 first engages the stationary contact 30. The contact carrier overtravel following the initial engagement of the contacts 30, 31 continues to compress the contact spring 40 thereby increasing the contact pressure.

The plurality of contact modules 6, in FIG. 1, attach to the cover 3 of housing 1 via stationary clip 58 and moveable clip 59, shown in FIG. 4. Each contact module position 68 includes a first lip 75 and a second lip 76, shown in FIG. 5. The contact module 4 is secured by hooking stationary clip 58 over either a first lip 75 or a second lip 76 and pivoting the module toward the cover to secure the moveable clip 59 over the remaining lip 75 or 76. The moveable clip 59 is spring loaded and provides the contact module 4 a snap fit to the cover 3. The contact module 4 is removed by grasping the mounting clip tab 69, withdrawing the moveable clip 59 from engagement with the lip 75 or 76 and pivoting the module 4 away from the cover 3.

The contact module 4 is reversible and can be installed in either a first position or a second position located 180° opposite one another. The first position is a normally closed position and the second position is a normally open position. FIG. 1 depicts the plurality of contact modules 6 installed in the second position. The contact position describes the position of the moveable contacts 31 in contact module 4 when the module 4 is installed and the electromagnetic contactor 10 is de-energized. The moveable snap 69 is secured to the second lip 76 when the contact module 4 is installed in the first position. The moveable snap 69 is secured to the first lip 75 when the contact module 4 installed in the second position.

The cover 3 includes contact position markings located at each contact module position 68, FIG. 5. The normally closed (“NC”) markings 83 are located on one side of the cover adjacent each first lip 75 and the normally open (“NO”) markings 82 are located on the second side adjacent each second lip 76. The markings 82, 83 provide a clear indication of the contact style of each installed contact module 4 when the contactor 10 is within sight.

In the first position, contact module 4 obscures the NC mark 83 at the contact module position 68 where it is installed. However, the NO mark 82 remains in plain view so that the user can quickly identify the normally open configuration of the module 4 installed in that particular contact module position 68. Conversely, the NC mark 83 is left in view and the NO mark 82 obscured if the contact module 4 position is reversed. The contact position markings 82, 83 may be marked in any manner that provides a permanent mark such as engraving, raised lettering, painting and the like.

The contact carrier 60, in FIG. 4, is offset from the center of the contact module 4 when the contact module 4 is fully assembled. The contact carrier second end 62 includes a roller 36, and an appendage comprised of a catch 73 extending perpendicular to an extension 38. The extension 38 serves to locate the catch 73 beneath the abutment lip 24 as will be described in detail herein. The preferred embodiment of FIG. 4 shows the catch 73 in the form of a shaft. However, it will be recognized that the catch can be embodied in a variety of structure such as hooks, extensions, abutments, protrusions or other geometric shapes capable of attaching the contact carrier 60 to the operator 18.

The operator 18 is equipped with a first set of abutments 19 and second set of abutments 20, shown in FIG. 3, that are located along the operator face 79 of the stem 27. The operator face 79 combined with the abutments 19, 20 form an engagement surface that has a variable height. Each set of abutments 19, 20 is made up of a individual abutments 21. A catch slot 77 is located in the stem 27 adjacent each abutment 21. The offset design allows the catch 73 and roller 36 to cooperatively engage the first set of abutments 19 when the contact module 4 is installed in a first position. In the first position, the moveable contacts 31 are installed in a normally open state because the contact carrier roller 36 rests on the operator face 79 when the contact module 4 is installed on a de-energized electromagnetic contactor 10. The extension 38 and catch 73 protrude beneath the operator face 79 in catch slot 77 when the roller 36 is resting on the operator face 79. In a second position, the moveable contacts 31 are forced closed because the contact carrier roller 36 rests on the abutment top 22 of one of the second set of abutments 20 and compresses return spring 63 when the electromagnetic contactor 10 is de-energized.

The contact carrier roller 36, FIG. 4, travels between the operator face 79 and the abutment top 22 of abutments 21 when the coil 13 is energized and the operator 18 is moved within the housing 1 by the motion of the armature 14 and attached armature holder 15. The contact carrier 60 of contact modules 6 installed in the normally open position, travel up the abutment slope 23 to the abutment top 22 when the coil 13 is energized and the operator 18 moves to its energized position. The contact carrier travel compresses the return spring 63 and the moveable contacts 31 are forced into the closed position when the contact carrier roller 36 comes to rest on abutment top 22. Only the return spring resists the contact carrier travel when the coil is energized and the contact carrier travel is initiated. Thus, the invention reduces inrush current because the contact springs 40 do not oppose the contact closing.

The return spring 63 assists in opening the normally closed contact pair 30, 31 when the operator 18 moves to the energized position. The contact carrier roller 36 of a contact module 4 installed in the normally closed state travels down the abutment slope 23 when the coil 13 is energized and the operator 18 moves to its energized position. The return spring 63 forces the contact carrier 60 downward. The downward motion of the contact carrier 60 forces the moveable contacts 31 away from stationary contacts 30 into an open position. Again the coil inrush is reduced with the invention.

The configuration of the second end of the contact carrier 63 and the operator 18 insure that a contact weld will not lead to a false position indication. The catch 73 and the abutment lip 24 are not in contact during normal operation. The catch 73 travels unimpeded beneath the abutment lip 24 during normal contactor operation because the contact carrier 60 and the operator 18 are unattached. However, the abutment lip 24 strikes the catch 73 when the operator 18 attempts to open a contact that is welded closed. The catch 73 attaches to the operator 18 in this manner so long as the operator 18 attempts to open the welded contacts. A “soft weld” may be broken when the separation force of operator 18 is applied to contact carrier 60 forcing the contact pair 30, 31 open. However, the contacts do not separate and the abutment lip 24 will remain attached to the catch 73 when the separation force is insufficient to break the weld. The operator position is fixed and the contact modules 6 and auxiliary contacts do not change position.

The contact carrier first end 61, in FIG. 4, provides accurate local contact position indication regardless of the energized state of the electromagnetic contactor 10. The contact carrier first end 61 protrudes through the contact module 4 so long as the moveable contacts 31 are closed. The contact carrier first end 61 is enclosed within the contact module 4 when the moveable contacts 31 are open. This allows a person within line of site of the contactor to reference the contact carrier first end for accurate local contact position and contactor status indications. These indications are accurate because a bound operator will not be able to change the position of the contact carrier 60 until the welded contacts separate. The side tabs 84 provide additional contactor status indication. The operator 18 is in the energized position when the side tab is closest to the contact modules 6. The operator is in the de-energized position when the side tabs are closest to the coil terminals 66, 67.

The accuracy of the remote indication provided by the auxiliary contacts is also assured with the invention. The position of the auxiliary contacts is dependent on the position of the operator 18. Therefore the auxiliary contacts will provide accurate status indication because the operator 18 will not move between the energized and de-energized position unless the welded contacts separate.

The electromagnetic contactor 10 of FIG. 1 can be supplied with a latching feature, shown in detail in FIG. 5. The latch 56 is an optional feature that can easily be field installed by the user. The latch 56 holds the operator 18 in the energized position without maintaining power on coil terminals 66, 67.

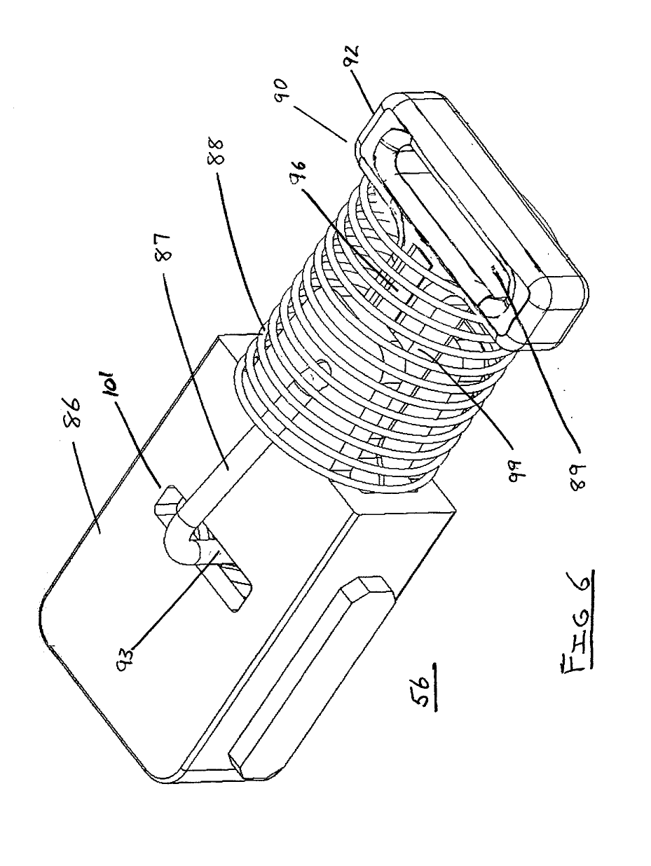

The latch 56, FIG. 6, includes a hollow shell 86, a body 90, a wire 87, and a latch spring 88. The body 90 includes a cup 95 located at one end of body 90. A neck 99 connects the cup 95 to a slotted end 92 located at the opposite end of the body 90. The cup 95 is inserted into the shell 86 when the latch 56 is assembled. A latch spring 88 is located around the neck 90. The latch spring 88 is trapped between the shell 86 and the slotted end 92 when the latch 56 is fully assembled. The slotted end 92 includes a latch tab slot 89 that captures the latch tab 54 located on the underside of the operator 18 when the electromagnetic contactor 10 is fully assembled.

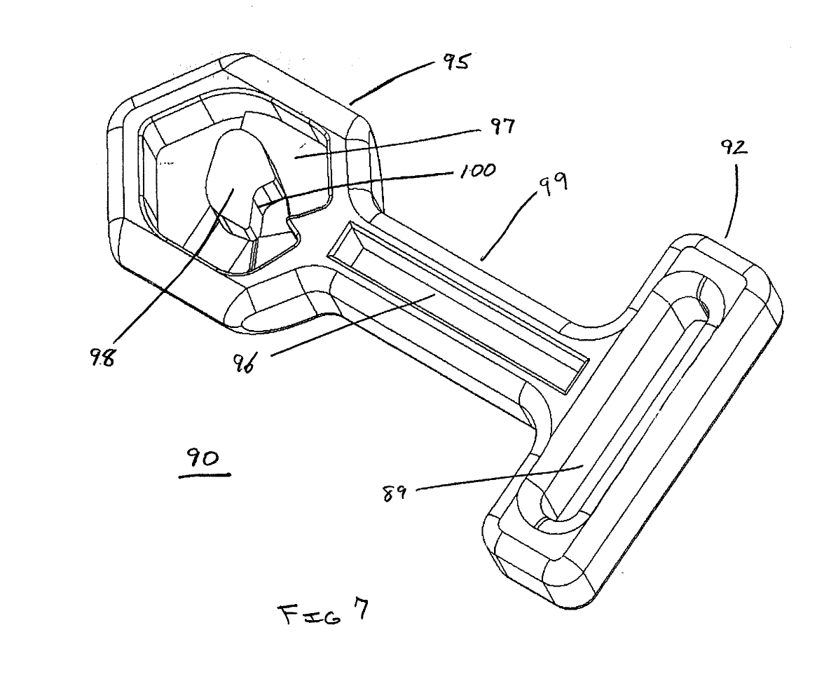

In FIG. 7 a spring slot 96 runs the length of the neck 99. A boss 98 is located within the cup 95. The boss 98 includes a detent 100 and is surrounded by an inclined surface 97. The inclined surface 97 slopes away from a peak that is located at the detent 100 to a low point located on the opposite side of the boss 98. A U-shaped wire 87 is installed with the wire second end (obstructed in FIG. 6) inserted in the spring slot 96 and the wire first end 93 (partially obstructed) cooperatively engaging the boss 98 and inclined surface 97.

The assembled latch 56 is inserted in the housing 1 from the underside of base 2 where a latch cover 57 secures the latch 56 in place, FIG. 1. The latch spring 88 is in a relaxed position when the latch 56 is installed in the base 2. The body 90 moves in unison with the operator 18, driving the neck 99 into the shell 86 and compressing the latch spring 88 when the coil 13 is energized and the operator 18 moves to the energized position. The body travel forces the wire first end 93 to rotate 180° around the boss 98. The boss 98 captures the wire first end 93 in detent 100. The latch spring force drives the body 90 in the de-energized direction. However, the body 90 is restrained by the latch wire 87 against the force of the compressed latch spring 88. There is a small amount of operator overtravel in the energized direction before the wire 87 stops the motion of the body 90 as it begins to travel in the de-energized direction.

Power is removed from the coil terminals 66, 67 by the electronic timer 8 after a factory pre-set period of time. The armature 14 returns to the de-energized position. However, the latch 56 prevents the operator 18 from being forced to the de-energized position by the operator spring 49.

The operator 18 will remain in the energized position until the coil 13 is re-energized. The armature 14 is pulled toward the magnet 11 where the flanges 16 engage the first foot 50 and the second foot 51. The operator 18 is forced in the energized direction a small amount when the coil 13 is energized. Travel in the energized direction releases the latch wire first end 93. The latch wire first end 93 rotates 180° clockwise around the boss 98, the latch spring 88 forces the body 90 out of the shell 86 and the operator 18 returns to the de-energized position.

An auxiliary contact input from auxiliary contact block 9 is supplied to the electronic timer 8 to ensure proper control sequence.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An electromagnetic contactor, comprising:
a housing;
a coil located within said housing;
at least one moveable contact;
at least one stationary contact;
a contact carrier that operates said moveable contact, wherein said contact carrier provides accurate contactor status indication regardless of the position of said moveable contact; and
an operator located within said housing, wherein said operator and said contact carrier are unattached during normal contactor operation, and said operator and said carrier attach when said contactor operates with said moveable and stationary contacts welded shut.

2. An electromagnetic contactor as claimed in claim 1, wherein said contact carrier includes an appendage capable of attaching said contact carrier to said operator.

3. An electromagnetic contactor as claimed in claim 2, wherein a contact carrier first end provides accurate local contact position feedback.

4. An electromagnetic contactor as claimed in claim 3, wherein said appendage is located at the contact carrier second end.

5. An electromagnetic contactor as claimed in claim 4, wherein said appendage is a catch.

6. An electromagnetic contactor as claimed in claim 5, wherein the operator includes an abutment having an abutment lip.

7. An electromagnetic contactor as claimed in claim 6, wherein said catch attaches to said abutment lip when said moveable contact is welded closed.

8. An electromagnetic contactor as claimed in claim 7, wherein said operator transfers a contact separation force capable of breaking a soft weld between said moveable contact and said stationary contact to said contact carrier via attachment of said catch to said abutment lip.

9. An electromagnetic contactor as claimed in claim 8, wherein said operator toggles an auxiliary contact to provide accurate control system contact position feedback.

10. An electromagnetic contactor as claimed in claim 9, wherein said coil is a continuous duty coil.

11. The electromagnetic contactor as claimed in claim 10, wherein said electromagnetic contactor is a lighting contactor.

12. An electromagnetic contactor that provides accurate contactor status indication, comprising:
a housing;
a coil located within said housing;
a reversible contact module that can be installed in either a normally open or a normally closed position;
a contact carrier; and
an operator located within said housing, wherein said operator cooperatively engages said contact carrier to move at least one moveable contact between an opened and a closed position when said coil is energized or de-energized.

13. An electromagnetic contactor as claimed in claim 12, wherein said moveable contact is open when said contact module is not installed in said contactor.

14. An electromagnetic contactor as claimed in claim 13, wherein a user can install said contact module with the moveable contact in either a normally open or a normally closed position.

15. An electromagnetic contactor as claimed in claim 14, wherein said contact module can be installed without the use of any tools.

16. An electromagnetic contactor as claimed in claim 15, wherein said contact module can be removed without the use of any tools.

17. An electromagnetic contactor as claimed in claim 16, wherein said contact carrier includes an appendage capable of attaching said contact carrier to said operator.

18. The electromagnetic contactor as claimed in claim 17, wherein said operator includes an operator stem having an engagement surface with a variable height.

19. The electromagnetic contactor as claimed in claim 18, wherein said operator stem includes an engagement surface having a variable height.

20. The electromagnetic contactor as claimed in claim 19, wherein said operator stem includes at least one set of abutments.

21. The electromagnetic contactor as claimed in claim 20, wherein said abutment includes an abutment slope and an abutment top.

22. The electromagnetic contactor as claimed in claim 21, said abutment slope of an abutment located at a first contact module position cooperatively engages a roller located at a contact carrier second end when said operator moves between an energized position and a de-energized position, said contact carrier located within a contact module installed in said first contact module position.

23. The electromagnetic contactor as claimed in claim 22, wherein said operator and said contact carrier are unattached during normal contactor operation, and said operator and said contact carrier attach when said contactor operates with said moveable and stationary contacts welded shut.

24. The electromagnetic contactor as claimed in claim 23, wherein position of a contact carrier first end provides accurate local contact position indication.

25. An electromagnetic contactor as claimed in claim 24, wherein said coil is a continuous duty coil.

26. The electromagnetic contactor as claimed in claim 25, wherein said electromagnetic contactor is a lighting contactor.

27. The electromagnetic contactor as claimed in claim 12, wherein said operator travels in an operator linear motion between said energized and said de-energized position.

28. The electromagnetic contactor as claimed in claim 27, wherein said engagement surface is a main cam that transfers the operator linear motion to a contact carrier linear motion.

29. The electromagnetic contactor as claimed in claim 28, wherein said contact carrier linear motion is perpendicular to said operator linear motion.

30. An electromagnetic contactor as claimed in claim 12, wherein the contact module includes a contact spring having a contact spring force and a return spring having a return spring force.

31. An electromagnetic contactor as claimed in claim 30, wherein one of the return spring force and the contact spring force does not oppose separation of a normally closed contact.

32. An electromagnetic contactor as claimed in claim 31, wherein neither the return spring force nor the contact spring force opposes separation of a normally closed contact.

33. An electromagnetic contactor as claimed in claim 32, wherein said return spring force contributes to separation of a normally closed set of contacts.

34. A method of manufacturing an low energy electromagnetic contactor that provides accurate contactor status indication, the steps comprising:
providing a contactor housing;
installing a magnet, an armature and a coil in said housing;
providing a contact carrier, wherein said contact carrier provides accurate contactor status indication; and
installing an operator, wherein said operator and said contact carrier are unattached during normal contactor operation, and said operator and said carrier attach when said contactor operates with a contact pair is welded shut.

35. The method of claim 34, wherein said contact pair is enclosed in a contact module.

36. The method of claim 35, wherein said contact module is reversible.

37. The method of claim 36, wherein a return spring having a return spring force is located in said contact module and said return spring force assists in opening a normally closed contact pair.

38. The method of claim 37, wherein said operator includes a plurality of abutments and an operator stem with an engagement surface having a variable height.

39. The method of claim 38, wherein an abutment lip attaches to a catch located adjacent an extension at a contact carrier second end when said contact pair is welded shut.

40. The method of claim 39, wherein said electromagnetic contactor is a lighting contactor.
